(19) United States
(12) Patent Application Publication
(10) Pub. No.: US 2007/0200392 A1
(43) Pub. Date: Aug. 30, 2007

(54) Driver's Cab For A Utility Vehicle Provided With A Sleeping Area

(75) Inventor: Markus Eiswirth, Durmersheim (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/574,106

(22) PCT Filed: Sep. 7, 2004
(86) PCT No.: PCT/EP04/09944

§ 371 Date: Jan. 12, 2007

(30) Foreign Application Priority Data
Oct. 2, 2003 (DE) 103 45 826.3

(51) Int. Cl. B62D 33/06

(52) U.S. Cl. 296/190.02

(57) ABSTRACT

The invention relates to a driver's cab (1) for a utility vehicle provided with a sleeping area which has a multipart mattress cushion (3).

In order, with little additional constructive outlay, to enable a driver to have particularly relaxing rest breaks, it is proposed to provide a back cushion (32) with an integrated massage device. In addition, a foot cushion (33) is provided with an automatically operated scissors-type lifting table (34).

The invention relates to a driver's cab for a utility vehicle according to the features of the precharacterizing clause of claim 1.

Drivers of utility vehicles are frequently exposed to stressful situations in road traffic. Furthermore, they are forced into an unchanging sitting position and thus suffer due to lack of movement. This results in drivers of utility vehicles frequently having to battle with muscle tenseness. In practice, massage chairs or massage tables are known with which it is possible to effectively combat such muscle tenseness. However, these massage devices are relatively large and heavy and are therefore unsuitable to be taken along in a utility vehicle.

DE 383 02 35 C2 shows a backrest for a seat of a utility vehicle having a pulsation cushion. This pulsation cushion is designed as a separate component and is fitted such that it bears against the backrest of the driver's seat. As an alternative solution, the pulsation cushion may also be removed from the driver's seat and arranged such that it rests on a mattress. The pulsation cushion requires supply lines which, for example, conduct compressed air from a compressed air connection to the pulsation cushion, and it is therefore relatively awkward to handle. In addition, when not in use, the pulsation cushion requires a place to keep it and therefore a storage space which is only available to a limited extent in a utility vehicle.

DE 100 45 138 A1 discloses a fitting system for a driver's cab of a utility vehicle, in which a plurality of different fitting system modules can be exchanged for one another and therefore different combinations of the driver's cab fitting system can be put together. This document makes provision, inter alia, for seats in which a massage system is integrated to be installed in the driver's cab. Such a massage system integrated in a seat has the disadvantage that it is primarily designed for use during the journey and, as a result, can only execute a small pulsation, since the driver of the utility vehicle must not be distracted during the journey from the events on the road. In addition, the massage system which is integrated in the seat forces the driver to stay in the unchanging sitting position even in the break times.

It is the object of the present invention to provide a driver's cab for utility vehicles which makes restful and relaxing breaks possible for the occupant, preferably the driver, with the intention being, with little constructive outlay, in particular for no additional construction space to be used.

This object is achieved according to the invention by a driver's cab with the features of claim 1.

The driver's cab has a sleeping area which is equipped with a multipart mattress cushion. One cushion part of the mattress cushion is designed as a back cushion with a massage device. The massage device, by means of vibrating or pulsating movements, can massage a back region of a person lying on the sleeping area. The lying position of the person enables a particularly effective relaxation of the muscles to be obtained. By the massage device being integrated in the back cushion of the mattress support, there is also no further need for the driver to change the driver's cab fitting system if he would like to use the massage function. When the massage device is switched off, the mattress can be used as a conventional sleeping area. In addition, no additional construction or storage space is required in the driver's cab for the massage device which also, when not in use, remains in position as part of the back cushion.

The back cushion with the massage device can be designed as an interchangeable back cushion. It is thus possible to interchange the massage device with a conventional back cushion. As a result, a simple retrofitting or refitting of an existing sleeping area is made possible. Also in the event of repair, a rapid and effective repair can thus be made possible by means of a simple interchanging of the massage device.

In one embodiment, the massage device can be designed as an electrically operated massage device. In particular, an electric motor or a plurality of electric motors can set the reclining surface of the mattress into vibrations or pulsating movements. A further possibility is for the drive for the massage device to take place pneumatically or hydraulically, i.e. the surface of the mattress is set into vibrating or pulsating movements with the aid of a fluid. The fluid used can be in particular the medium of compressed air which is generally already present in utility vehicles.

In an advantageous refinement of the invention, it can be provided that the foot cushion of the mattress can be adjusted in height by means of a lifting device. The leg support for the person lying on the mattress can therefore be adjusted in height, in particular automatically. As a result, a particularly relaxing reclining position and hence an effective massage are possible. In addition, the sleeping area can have an ergonomically shaped neck cushion which permits a relaxing and fatigue-free head and neck position. The lifting device for the leg support surface can in particular be designed to be integrated in the foot part of the multipart mattress cushion. The lifting device therefore does not require any additional construction space in comparison to a conventional mattress. As an alternative, the lifting device may also be integrated in the supporting surface of the mattress.

It is preferably provided that the lifting device is designed as an electrically adjustable scissors-type lifting table. However, the lifting device may also have one or more cable pulls which are moved by means of electric motor and latch in the desired position.

In one embodiment, it is provided that the mattress cushion is designed such that it bears against a wall of the driver's cab and, in this case, the multipart mattress cushion can be designed, for example, as a support for the lower sleeping area or as a support for the upper sleeping area in a driver's cab, preferably double cabin of a utility vehicle.

In an advantageous embodiment, it is provided that the massage device has a control device which makes it possible to set individual sequence and/or massage programs. It can also be provided that the control device has a preselectable timer, for example the driver can switch off or else switch on the massage function after a preselectable time.

Further advantageous refinements and features of the invention are explained with reference to the drawings, in which:

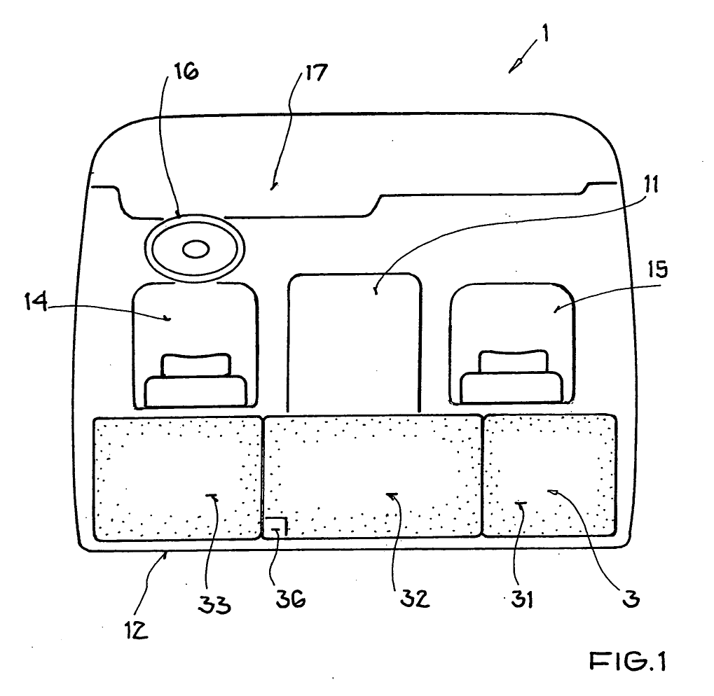

FIG. 1 shows a driver's cab of a utility vehicle with a massage device.

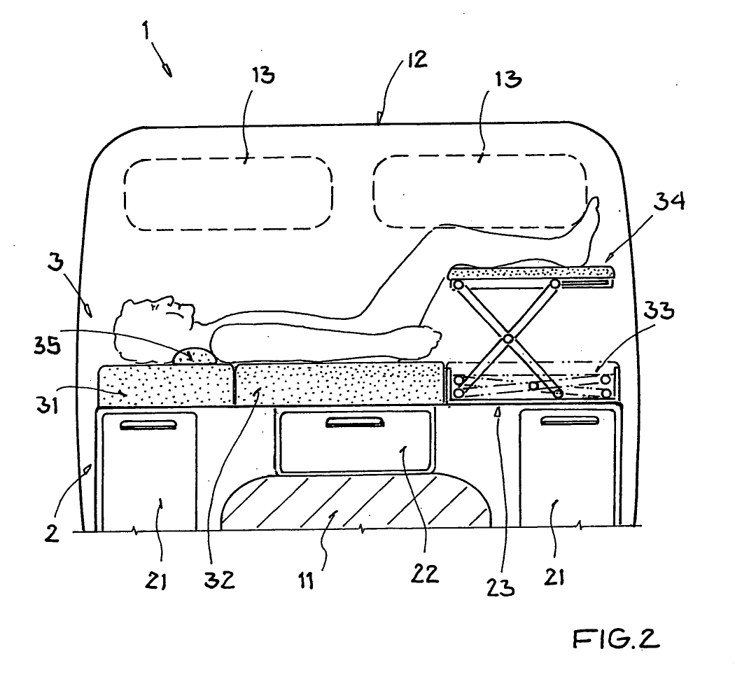

FIG. 2 shows a section through the utility vehicle and the massage device in a diagrammatic side view.

FIG. 1 illustrates a driver's cab 1 of a utility vehicle. The driver's cab 1 is what is referred to as a double cabin with a driver's seat 14 and a passenger seat 15. A central tunnel with a central tunnel tray 11 is arranged between driver's seat and passenger seat. On the front side of the driver's cab 1, an instrument panel 17 extends over the entire width of the driver's cab. Vehicle operating elements, such as, for example, a steering wheel 16, are arranged on the instrument panel 17. A sleeping area with a mattress 3 is arranged behind the backrests of the driver's seat 14 and of the passenger seat 15. The sleeping area or the mattress 3 runs along the rear wall of the driver's cab 12 over the entire width thereof.

The mattress 3 is divided into three and has a head cushion 31, a back cushion with massage device 32 and a foot cushion 33. The cushions 31, 32 and 33 are at the same height and are arranged such that they bear directly against one another, so that a continuous, gap-free reclining surface is produced. A connection 36 is provided in the region of the back cushion or of the massage device 32, said connection being arranged on the supporting surface of the mattress 3, preferably on a storage box 2. The connection 36 is designed as a supply connection for the massage device and supplies the latter with power. The massage device 32 has a plug which enters into a releasable connection with the connection 36.

FIG. 2 shows a section through the driver's cab in the region of the sleeping area. The mattress 3 with the head cushion 31, massage device 32 and foot cushion 33 is arranged such that it rests on a storage box 2. The storage box 2 has various storage spaces which are designed as a storage and depositing area. Storage boxes 21 which are accessible from above and the outside are arranged on the left and right of the center console 11, and a drawer 22 is integrated in the storage box 2 in the center above the center console 11. Further storage compartments 13 which serve for the depositing of diverse objects are arranged on the rear wall 12 above the mattress 3. In one embodiment, an air conditioning system for operation when the vehicle is stationary can be provided on the rear wall 12.

The head cushion 31 of the mattress cushion 3 has an ergonomically shaped neck support, preferably a neck cushion 35. The foot cushion 33 has a scissors-type lifting table 34 with which the leg support surface can be adjusted infinitely variably in height. As a result, the person reclining on the mattress can adopt a particularly relaxed reclining position, which is effective for a massage, irrespective of the height of the person. The central cushion of the mattress 3 is designed as a back cushion with a massage device 32 and massages the back of a person lying on the mattress 3. The shifting of the height of the legs of the reclining person produces a particularly intensive contact between the person's back and the back cushion 32 and therefore permits an effective and relaxing massage.

The massage device 32 is designed as an electrically operated massage device and is supplied with electric power via the connection 36. A certain program can be selected from various programs stored in the control device or a preselectable duration of the massage can be determined via a control device (not illustrated).

The lifting device 34 of the leg support is designed as an electrically operated scissors-type lifting table, so that the person reclining on the mattress 3 can adjust the leg support in height conveniently by pressing a button. The cushion parts 31, 32 and 33 of the multipart mattress 3 lie on a flat mattress supporting surface 23 which is arranged on the top side of the storage box 2. The cushion parts 31, 32 and 33 are at an identical height, thus producing a continuous and flat reclining surface for the person reclining on the mattress.

1-10. (canceled)

11. A driver's cab for a utility vehicle provided with a sleeping area which has a multipart mattress cushion comprising:
a first cushion part designed as a head cushion,
a second cushion part designed as a foot cushion, and
a third cushion part designed as a back cushion,
wherein the back cushion is a massage device which, by vibrating movements, is designed to massage a back region of a person lying on the sleeping area.

12. The driver's cab as claimed in claim 11, wherein the back cushion which is a massage device is interchangeable.

13. The driver's cab as claimed in claim 11, wherein the massage device is designed as an electrically, pneumatically, or hydraulically operated massage device.

14. The driver's cab as claimed in claim 11, wherein the head cushion has an ergonomically shaped neck support.

15. The driver's cab as claimed in claim 11, wherein the foot cushion has a leg support surface which can be adjusted in height by way of a lifting device.

16. The driver's cab as claimed in claim 15, wherein the lifting device is designed to be integrated into the foot cushion.

17. The driver's cab as claimed in claim 11, wherein the multipart mattress cushion is arranged such that it rests on a storage box.

18. The driver's cab as claimed in claim 17, wherein the storage box has an electric, pneumatic, or hydraulic connection for supplying the massage device with power.

19. The driver's cab as claimed in claim 11, wherein the massage device has a control device which has a plurality of preselectable massage program sequences, a preselectable timer, or both a plurality of preselectable massage program sequances and a preselectable timer.

20. The driver's cab as claimed in claim 11, wherein the head cushion, the foot cushion, and the back cushion are at the same height so that, when the supporting surface for the mattress cushions is flat, a flat reclining surface is produced.

21. The driver's cab as claimed in claim 15, wherein the lifting device is a scissors-type lifting device.

22. The driver's cab as claimed in claim 17, wherein the multipart mattress cushion adjoins a wall of the driver's cab.

23. The driver's cab as claimed in claim 22, wherein the wall of the driver's cab has an electric, pneumatic, or hydraulic connection for supplying the massage device with power.

24. The driver's cab as claimed in claim 12, wherein the massage device is designed as an electrically, pneumatically, or hydraulically operated massage device.

25. The driver's cab as claimed in claim 12, wherein the head cushion has an ergonomically shaped neck support.

26. The driver's cab as claimed in claim 13, wherein the head cushion has an ergonomically shaped neck support.

27. The driver's cab as claimed in claim 12, wherein the foot cushion has a leg support surface which can be adjusted in height by way of a lifting device.

28. The driver's cab as claimed in claim 13, wherein the foot cushion has a leg support surface which can be adjusted in height by way of a lifting device.

29. The driver's cab as claimed in claim 14, wherein the foot cushion has a leg support surface which can be adjusted in height by way of a lifting device.

30. A multipart mattress adapted for use in a driver's cab for a utility vehicle provided with a sleeping area, comprising:
a first cushion part designed as a head cushion,
a second cushion part designed as a foot cushion, and
a third cushion part designed as a back cushion,
wherein the back cushion is a massage device which, by vibrating movements, is designed to massage a back region of a person lying on the sleeping area.
